(19) United States
(12) Patent Application Publication
(10) Pub. No.: US 2020/0271109 A1
(43) Pub. Date: Aug. 27, 2020

(54) PISTON DRIVE DEVICE

(71) Applicant: SHINANO KENSHI CO., LTD., Ueda-shi (JP)

(72) Inventors: Hironori NAKAJIMA, Nagano (JP); Keita MORISAKI, Nagano (JP)

(73) Assignee: SHINANO KENSHI CO., LTD., Ueda-shi (JP)

(21) Appl. No.: 16/747,741

(22) Filed: Jan. 21, 2020

(30) Foreign Application Priority Data
Feb. 27, 2019 (JP) 2019-034210

(51) Int. Cl. F04B 9/04; F02B 55/02; F02B 55/14; F02B 57/08

(52) U.S. Cl. CPC F04B 9/045; F02B 57/08; F02B 55/14; F02B 55/02

(57) ABSTRACT

A piston drive device includes: a motor; an eccentric body provided at an eccentric position with respect to a rotation axis of the motor and revolving about the rotation axis in conjunction with rotation of the motor; a piston holder swinging about the rotation axis in conjunction with revolving of the eccentric body; and pistons held by the piston holder in such a manner as to be positioned radially about an eccentric axis of the eccentric body, wherein the pistons are arranged in a same plane perpendicular to the eccentric axis.

### CROSS-REFERENCE TO RELATED APPLICATION

This application is based upon and claims the benefit of priority of the prior Japanese Patent Application No. 2019-034210, filed on Feb. 27, 2019, the entire contents of which are incorporated herein by reference.

### BACKGROUND

### (i) Technical Field

The present disclosure relates to a piston drive device.

### (ii) Related Art

There is known a device, such as a compressor or a vacuum machine, driving pistons by a motor. For example, in a device of Japanese Unexamined Patent Application Publication No. 2014-92083, the pistons are arranged away from each other in the direction of a rotation axis of the motor.

### SUMMARY

According to an aspect of the present disclosure, there is provided a piston drive device including: a motor; an eccentric body provided at an eccentric position with respect to a rotation axis of the motor and revolving about the rotation axis in conjunction with rotation of the motor; a piston holder swinging about the rotation axis in conjunction with revolving of the eccentric body; and pistons held by the piston holder in such a manner as to be positioned radially about an eccentric axis of the eccentric body, wherein the pistons are arranged in a same plane perpendicular to the eccentric axis.

### BRIEF DESCRIPTION OF THE DRAWINGS

FIG. 1 is a perspective view of a piston drive device;

FIG. 2 is a front view of the piston drive device;

FIG. 3 is a cross-sectional view taken along line A-A of FIG. 1;

FIG. 4 is a front view of a motor housing with a piston holder, pistons, and cylinders removed; and

FIG. 5 is a cross-sectional view taken along line B-B of FIG. 4.

### DETAILED DESCRIPTION

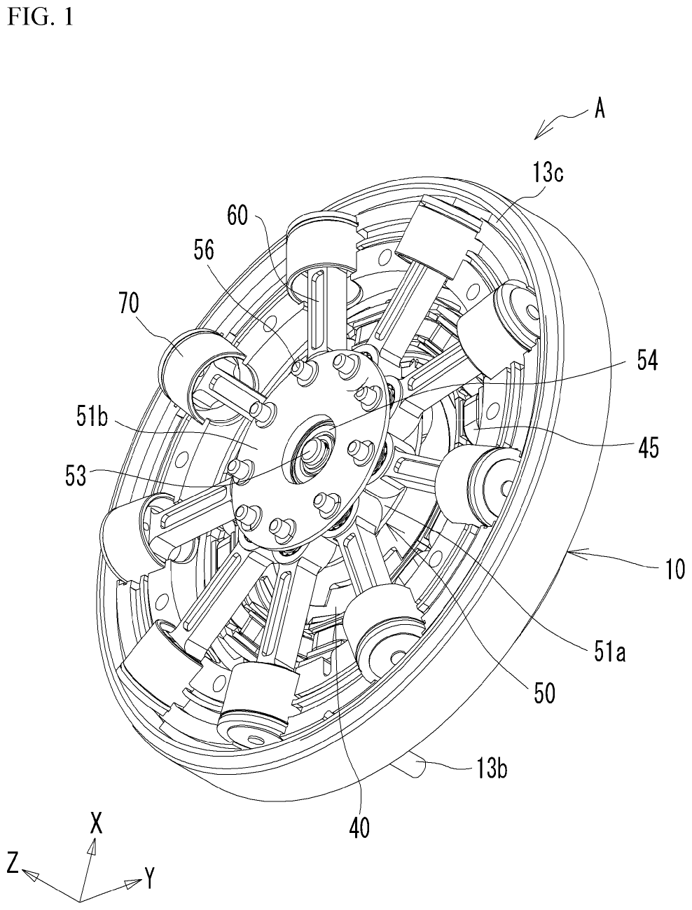

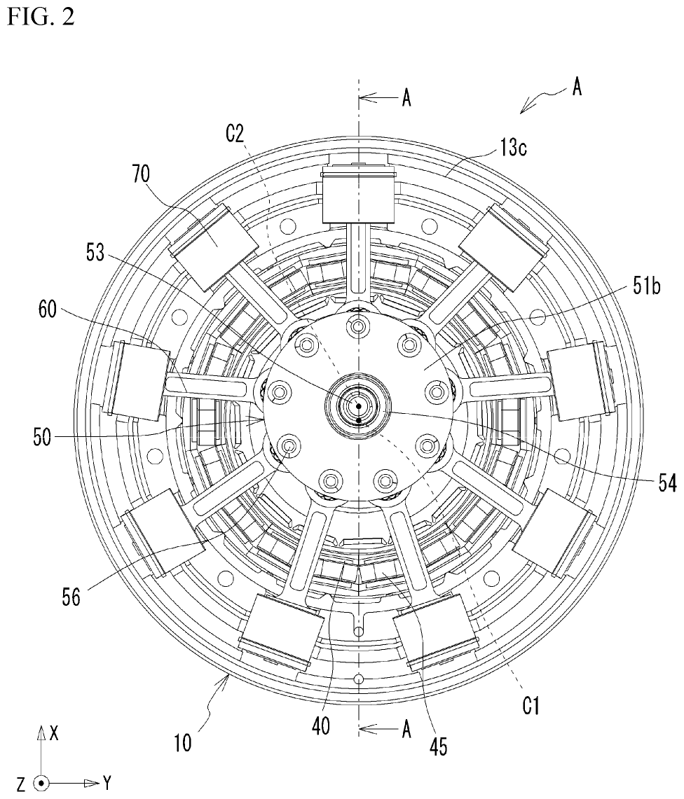

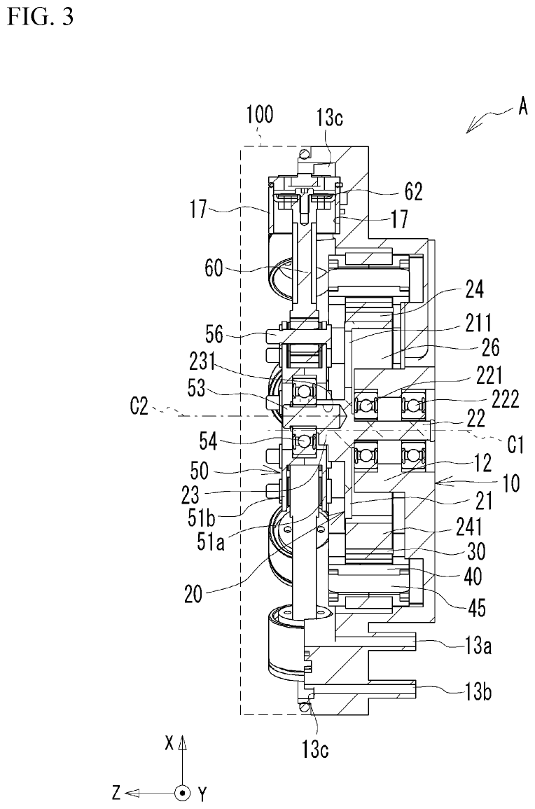

FIG. 1 is a perspective view of a piston drive device A. FIG. 2 is a front view of the piston drive device A. FIG. 3 is a cross-sectional view taken along line A-A of FIG. 1. FIGS. 1 and 2 illustrate the piston drive device A with a cover 100 removed, as will be described later, and FIG. 3 illustrates the cover 100 in a simplified manner. FIGS. 1 to 3 illustrate X, Y, and Z directions perpendicular to one another. The piston drive device A is an example of a piston drive device driving pistons 60 by the power of a motor. The piston drive device A is a compressor, but is not limited thereto, and may be a vacuum machine.

First, a brief description of the motor. The motor is an inner rotor type and includes a motor housing 10, a rotor 20, a permanent magnet 30, and a stator 40. The motor housing 10 is made of, for example, synthetic resin or metal, and the cover 100 is the same. The motor housing 10 holds the rotor 20 rotatably and holds the stator 40 having an annual shape. The rotor 20 holds permanent magnets 30. The stator 40 is disposed on the radially outer side of the rotor 20. Coils 45 are respectively wound around teeth portions of the stator 40. By controlling energization of the coils 45, the stator 40 is excited, and the rotor 20 is rotated by magnetic attractive force or magnetic repulsive force generated between the stator 40 and the permanent magnets 30.

The rotor 20 includes a circular plate portion 21, a rotational shaft portion 22, an eccentric portion 23, and a cylindrical portion 24. The rotational shaft portion 22 protrudes from the circular plate portion 21 in the −Z direction. The eccentric portion 23 protrudes from the circular plate portion 21 in the +Z direction. The cylindrical portion 24 extends from an outer edge of the circular plate portion 21 in the −Z direction in a substantially cylindrical manner. The rotor 20 rotates about the rotational shaft portion 22 as a support shaft. The permanent magnets 30 are held in the cylindrical portion 24. Outer surfaces of the permanent magnets 30 are arranged such that south poles and north poles are alternately arranged in the circumferential direction.

In the eccentric portion 23, a fitted recess portion 231 is formed at a position eccentric from the rotation axis C1 of the rotational shaft portion 22. When the rotational shaft portion 22 rotates about a rotation axis C1, the eccentric portion 23 revolves about the rotation axis C1. The eccentric portion 23 revolves to swing a piston holder 50 described later. When the piston holder 50 swings, the pistons 60 reciprocate.

Next, the piston holder 50 will be described. The piston holder 50 holds the pistons 60 in such a manner to be positioned radially about an eccentric axis C2. The piston holder 50 includes holding plates 51a and 51b that sandwich root portions of the pistons 60 in the Z direction. Each of the holding plates 51a and 51b is formed into a circular plate shape having an opening at a center. The holding plate 51a is arranged on the +Z direction side from the holding plate 51b.

The holding plates 51a and 51b are fixed with support spindle pins 56 that penetrates the root portions of the pistons 60 together with the holding plates 51a and 51b. The support spindle pin 56 extends in the Z direction. The support spindle pin 56 is inserted from the holding plate 51b side. A front end of the support spindle pin 56 protrudes from the holding plate 51a. The root portion of the piston 60 is rotataby supported about the support spindle pin 56. The support spindle pins 56 are fixed to the holding plates 51a and 51b at even intervals around the eccentric axis C2. In this manner, the pistons 60 are arranged radially. The support spindle pin 56 is an example of a support spindle portion.

Further, the holding plates 51a and 51b sandwich a bearing 54. The bearing 54 holds a swing pin 53 for rotation. The swing pin 53 is fitted into the fitted recess portion 231 of the eccentric portion 23 so as not to rotate. When the eccentric portion 23 revolves about the rotation axis C1, the swing pin 53 also revolves in the same manner. The swing pin 53 pivots, so the bearing 54 and the holding plates 51a and 51b swing around the rotation axis C1 while maintaining a predetermined posture. In other words, the piston holder 50 revolves around the rotation axis C1 while being restrained from rotating about the eccentric axis C2.

A cylinder 70 having a cylindrical shape is attached to a piston head 62 that is formed at a distal end of the piston 60. The piston holder 50 swings, so the piston head 62 slides in contact with the inner surface of the cylinder 70 and reciprocates in an axial direction of the cylinder 70.

The motor housing 10 is provided with cylinder holding portions 17 for respectively holding the cylinders 70. The cylinder holding portion 17 holds the cylinder 70 in such a posture that the axial direction of each cylinder 70 is the same as the radial direction about the rotation axis C1. The cylinder holding portions 17 are provided on the same circumference about the rotation axis C1. The cylinder holding portion 17 is curved and recessed along the outer peripheral surface of the cylindrical cylinder 70. Also, the cover 100 is provided with a cylinder holding portion having the same shape as the cylinder holding portion 17.

The motor housing 10 is provided with a communication path 13c at a radially outward from the cylinders 70. The communication path 13c through which air compressed by the reciprocating motion of the piston 60 in the cylinder 70 flows is formed in a circular shape. As illustrated in FIG. 3, an intake nozzle 13a and an exhaust nozzle 13b are provided. The intake nozzle 13a communicates with the inside of the motor housing 10. The exhaust nozzle 13b communicates with the communication path 13c. When the piston head 62 reciprocates in the cylinder 70, air is sucked into the motor housing 10 from the intake nozzle 13a, and the air is compressed by the piston head 62 in the cylinder 70. The compressed air is discharged from the exhaust nozzle 13b through the communication path 13c.

As illustrated in FIGS. 1 to 3, the pistons 60 are arranged in the same XY plane. Specifically, the support spindle pins 56 that respectively support the pistons 60, and the pistons 60 are arranged in the same XY plane. This achieves size reduction of the piston drive device A in the Z direction.

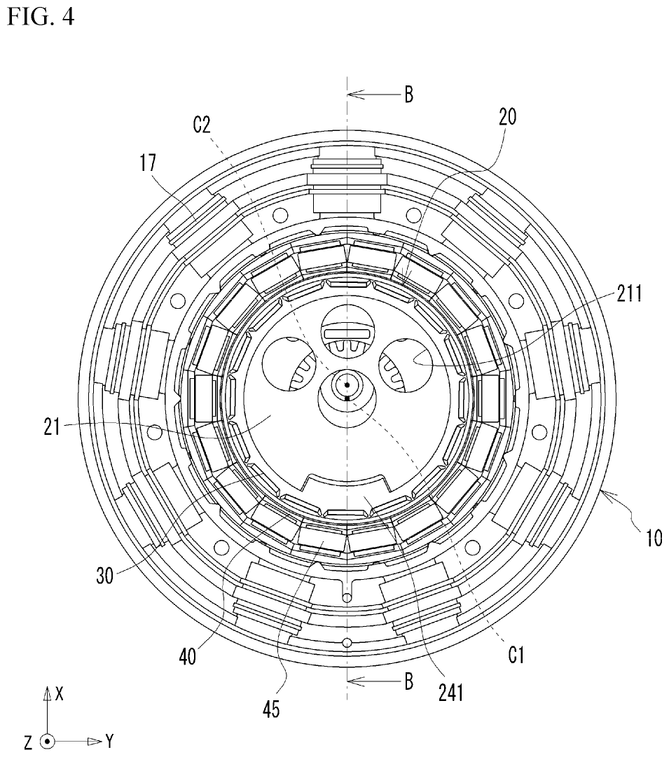

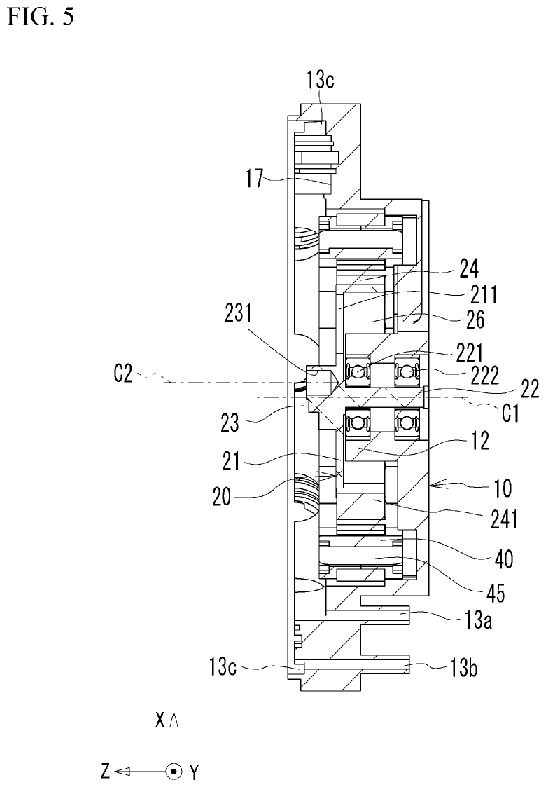

Next, the motor will be described. FIG. 4 is a front view of the motor housing 10 with the piston holder 50, the pistons 60, and the cylinders 70 removed. FIG. 5 is a cross-sectional view taken along line B-B of FIG. 4. A bearing holding portion 12 of the motor housing 10 extends inside the motor housing 10 in a substantially cylindrical shape, and holds two bearings 221 and 222. The bearings 221 and 222 hold the rotational shaft portion 22 for rotataion. Specifically, the bearing 221 supports a root portion of the rotational shaft portion 22 for rotation. The bearing 222 supports an end portion of the rotational shaft portion 22 for rotation.

Further, the circular plate portion 21 and the cylindrical portion 24 of the rotor 20 define a recess portion 26 on the −Z direction side from the circular plate portion 21. In other words, the rotor 20 has a cylindrical shape having a bottom. An end side of the bearing holding portion 12 is disposed in the recess portion 26. In other words, the circular plate portion 21 faces the end side of the bearing holding portion 12, and the bearing holding portion 12 is surrounded by the cylindrical portion 24. Herein, as illustrated in FIG. 5, a part of the bearing holding portion 12, the bearing 221, the cylindrical portion 24 of the rotor 20, the permanent magnets 30, the stator 40, and the coils 45 are disposed in the same XY plane. This also reduces the size of the motor in the Z direction.

Further, as described above, the cylinder holding portion 17 of the motor housing 10 holds the cylinder 70. That is, a member holding the piston 60 and the cylinder 70, and the motor housing 10 holding the motor are integrally formed. This also reduces the size of the piston drive device A in the Z direction.

The balancer portion is integrated with the rotor 20. Specifically, as illustrated in FIG. 4, three hole portions 211 are formed in the circular plate portion 21 on a side where the eccentric axis C2 is eccentric with respect to the rotation axis C1, thereby reducing the weight. Further, a protruding portion 241 that protrudes inward from the cylindrical portion 24 is formed on a side opposite to the side where the eccentric axis C2 is eccentric with respect to the rotation axis C1, thereby increasing the weight. In other words, a radial thickness of the protruding portion 241 is greater than other parts of the cylindrical portion 24.

As described above, center of gravity of the rotor 20 is shifted to the side opposite to the side where the eccentric axis C2 is eccentric with respect to the rotation axis C1. In such a way, the balancer portion is integrated with the rotor 20. For example, as compared with the case where a balancer is separately provided at the end side of the rotational shaft portion 22, size reduction in the Z direction is achieved. In addition, the number of parts is reduced, and an increase in manufacturing cost is also suppressed.

The intake nozzle 13a and the exhaust nozzle 13b extend in the −Z direction as illustrated in FIG. 3, but are provided so as not to protrude outward from the height range of the piston drive device A in the Z direction. This also reduces the size of the piston drive device A in the Z direction.

While the exemplary embodiments of the present invention have been illustrated in detail, the present invention is not limited to the above-mentioned embodiments, and other embodiments, variations and variations may be made without departing from the scope of the present invention.

The above-described embodiment describes the inner rotor type motor as an example, but an outer rotor type motor may be used in the same manner. When the outer rotor type motor is used, a stator may be disposed radially inside from a cylindrical portion of a rotor. For example, the stator may be provided so as to be fitted onto an outer peripheral surface of the bearing holding portion 12.

What is claimed is:

1. A piston drive device comprising:
a motor;
an eccentric body provided at an eccentric position with respect to a rotation axis of the motor and revolving about the rotation axis in conjunction with rotation of the motor;
a piston holder swinging about the rotation axis in conjunction with revolving of the eccentric body;and
pistons held by the piston holder in such a manner as to be positioned radially about an eccentric axis of the eccentric body,
wherein the pistons are arranged in a same plane perpendicular to the eccentric axis.

2. The piston drive device according to claim 1, wherein
the piston holder includes support spindle portions respectively supporting the pistons for swinging, and being positioned away from the eccentric axis,
the support spindle portions and the pistons are arranged in the same plane perpendicular to the eccentric axis.

3. The piston drive device according to claim 1, wherein
the motor includes:
a rotor including:
a circular plate portion;
a rotational shaft portion provided in the circular plate portion;
a cylindrical portion extending from the circular plate portion, and
a permanent magnet held in the cylindrical portion;
a stator disposed radially outside or inside the cylindrical portion; and
a motor housing holding the rotor and the stator,
the motor housing includes a bearing holding portion,
the bearing holding portion holds a bearing,
the bearing rotatably supports the rotational shaft portion, and
at least a part of the bearing holding portion, at least a part of the bearing, at least a part of the cylindrical portion, at least a part of the permanent magnet, and at least a part of the stator are in a same plane perpendicular to the rotation axis.

4. The piston drive device according to claim 3, wherein the motor housing includes a cylinder holding portion that holds cylinders with which the pistons are respectively in sliding contact.

5. The piston drive device according to claim 3, wherein the circular plate portion and the cylindrical portion are integrally formed with a balancer portion so as to shift a position of a center of gravity of the rotor in a direction opposite to a direction in which the eccentric axis is eccentric with respect to the rotation axis.
